(19) United States
(12) Patent Application Publication
(10) Pub. No.: US 2003/0018628 A1
(43) Pub. Date: Jan. 23, 2003

(54) System and method for automated management of electronic information derivatives

(76) Inventor: Yih-Ping Luh, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/053,087

(22) Filed: Nov. 2, 2001

(30) Foreign Application Priority Data
Jul. 18, 2001 (TW) 90117492

(51) Int. Cl. G06F 7/00

(52) U.S. Cl. 707/3

(57) ABSTRACT

A method and structure for managing information objects is disclosed herein, wherein an item master is provided to logically link a BOM (bill of material) to one or more databases, thereby constituting an information relationship between the BOM and the one or more databases. In accordance with a version management rule, the user can rebuild a new item master and its logic link between the BOM and related one or more databases so as to maintain information correctness and manage the versions of the BOM.

### BACKGROUND OF THE INVENTION

1. Field of the Invention

The present invention relates to systems for automated management of electronic information. In particular, electronic information that is needed by a variety of users whether in original form, modified form, or a combination of original and modified forms.

2. Description of Related Art

A conventional electronic information system has an item master for obtaining all information about a particular subject-matter. The subject-matter may be a particular product designed or produced by a company. Normally, a system designer links all kinds of information about the product to the item master. The linked information may include matters such as design, manufacture, quality, operation, and marketing. All such information related to the product can then be searched through the item master. The information system typically also comprises a so-called BOM (Bill of Material) information object. The BOM object is essentially a list of materials needed for manufacturing the product. In a conventional information system, the term “BOM” has been expanded to terms including DBOM (Design BOM), MBOM (Manufacturing BOM) and PBOM (Plan BOM). This definition of BOM refers to hierarchy structure in designing, manufacturing or programming. DBOM, MBOM and PBOM information objects are now commonly used in present-day information systems. If a BOM is defined as a hierarchy structure of an item master, then uses can find corresponding related information through choosing different kinds of BOMs.

During development of a new product, materials needed for manufacturing the product frequently undergo change. For example, the structure or specifications of sub-components of the new product frequently undergo modification. Information relating to such sub-components is accordingly changed. Various users of an information system such as designers of the new product respectively need such information on the sub-components in original form, modified form, or a combination of original and modified forms. Conventional information systems do not adequately distinguish between different versions of modified information stored in the system, and do not adequately handle such versions as required by users. This is particularly so in very large systems where a very large number of users need to share any of numerous versions of the modified information with each other.

A system and method for automated management of modified information that overcomes the above-mentioned difficulties is desired.

### SUMMARY OF THE INVENTION

It is a primary object of the present invention to provide a version management method for information objects. This method is used to distinguish versions of information objects and maintain information correctness, after a user has changed the version of the BOM and some related information (e.g., all kinds of databases) in an information system.

It is another object of the present invention to provide a management structure for information objects which can record clearly versions' information of related information objects in an information system. Users can also search related versions' information conveniently.

As disclosed in the method of the present invention, the information relation between the BOM and the related information is created through a logical link to an item master, and this information relation is called exclusive link. The exclusive link can maintain coherence between the BOM and the related information. Once the user changes the BOM, according to the rule of version management, a version management module will rebuild an item master and an exclusive link of the changed version that exclusively links the BOM to the related information. With this method, correct versions between related information objects may be maintained and distinguished.

### BRIEF DESCRIPTION OF THE DRAWINGS

FIG. 1 is a schematic illustration of an information system used in conjunction with a management system of the present invention;

FIG. 2 is a schematic illustration of a tree structure of BOM nodes of a BOM object of the information system of FIG. 1;

FIG. 3A is a schematic illustration of information objects linked by exclusive links according to the information system of FIG. 1, in particular showing a one-to-many exclusive link relation as between a bill of material node and related database objects;

FIG. 3B is similar to FIG. 3A, but in particular showing a many-to-many relation as between bill of material nodes and related database objects;

FIG. 4 is a schematic illustration of a version management rule and version management sub-rules of the management system of the present invention;

FIG. 5 is a flowchart of a management method of the present invention;

FIG. 6A is a schematic illustration of an information object added into an information system used in conjunction with a management system of the present invention;

FIG. 6B is similar to FIG. 6A, but includes using of an old information object of the information system in accordance with the management system;

FIG. 6C is similar to FIG. 6B, but includes referring of an information object of the information system in accordance with the management system; and

FIG. 6D is similar to FIG. 6C but includes modifying of an information object of the information system in accordance with the management system.

### DETAILED DESCRIPTION OF THE INVENTION

A management system in accordance with the present invention operates in conjunction with an information system. The information system comprises many kinds of information objects related to each other. Each information object may be stored in any one of a variety of information storage devices of a computer. Such storage devices can include, for example, hard disk drives, CDs, and floppy diskettes. The information object may be a single file, a file directory comprising many files, or a tree structure. The type of information may be a document, database, video, image or audio.

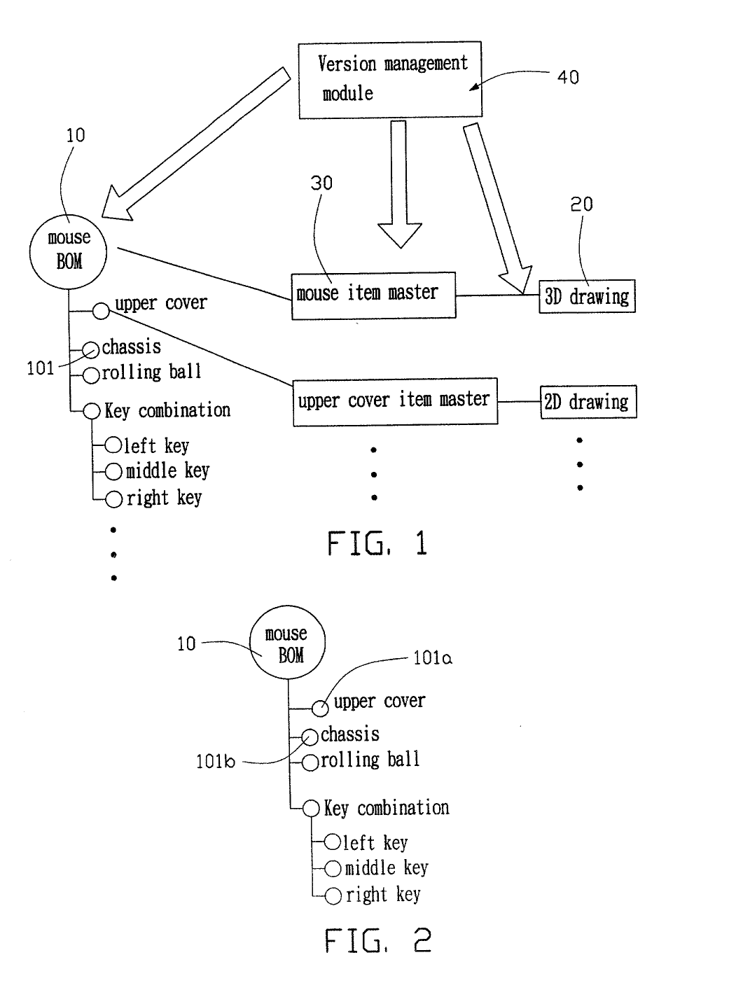

Referring to FIG. 1, the information system in the present invention has some information objects. The information objects include item master objects 30, bills of material (BOM) objects 10, and related information objects that are related to the BOMs 10. The related information objects are stored in a database. Accordingly, the related information objects are hereinafter called DB objects 20. A version management module 40 is used to manage original and modified forms of the information of all these various information objects.

Referring also to FIG. 2, the BOM object 10 comprises a plurality of information nodes organized in a hierarchical tree structure. Each node is hereinafter called a BOM node 101. To distinguish between various BOM nodes 101, they are hereinafter designated as BOM node 101a, BOM node 101b, and so on. The nodes can store information about any subject-matter. For example, the subject-matter may be a product such as a computer mouse, a project such as a sales project, or a constitution of an organization such as a tree diagram of the organization's personnel. In the present invention, the BOM object 10 is not limited to the structure of a product. It could also, for example, include information about a plan, an item of software, an accessory of a product, and management of inventory, personnel or finances.

Each DB object 20 is used to store many kinds of related information. The information may be stored in a variety of forms as indicated previously.

Each item master 30 is used to connect and integrate all related information objects in the information system. In particular, the item master 30 is used to create the information between the BOM object 10 and the relational DB object 20.

FIGS. 1 and 2 include examples of one BOM object 10, one DB object 20 and one item master 30. The examples help explain the structures of and interrelationships between these three information objects. The BOM object 10 is used to record the structure of a product such as a mouse. A user can find out about components of the mouse by referring to the hierarchical structure of the BOM nodes 101. For example, an upper cover BOM node 101a provides information about the upper cover of the mouse, the chassis BOM node 101b provides information about the chassis of the mouse, and so on.

Since the BOM object 10 comprises a tree structure of BOM nodes 101, it may be used as an interface for users of the information system. Through every BOM node 101, a user can find all information related to the BOM node 101 that is stored in the DB objects 20. For example, a user can select an upper cover BOM node 101a by clicking on a monitor display of that node, and search information stored in the DB objects 20 that is related to the mouse's upper cover. Such related information may include a table of the mouse's structure, the material of the upper cover, and the price of the upper cover. In other words, through a BOM node 101, a user can find all information logically related to that BOM node 101. In the present invention, two types of logical links between the BOM nodes 101 and related information are configured. The first type is called an exclusive link. An exclusive link is automatically modified when a corresponding BOM node 101 is modified. The other type is called a reference link. A reference link only relates to reference information of a BOM node 101. Reference information is described in more detail later on.

Each exclusive link connects a BOM node 101 with a DB object 20 via a corresponding item master 30. That is, the BOM node 101 and the related DB object 20 are respectively linked to the same item master 30 through the exclusive link. The item master 30 functions as a secretary of the BOM node 101, by responding to all requests made by users at the BOM node 101. For example, an item master 30 linked to an upper cover BOM node 101a is called an upper cover item master 30.

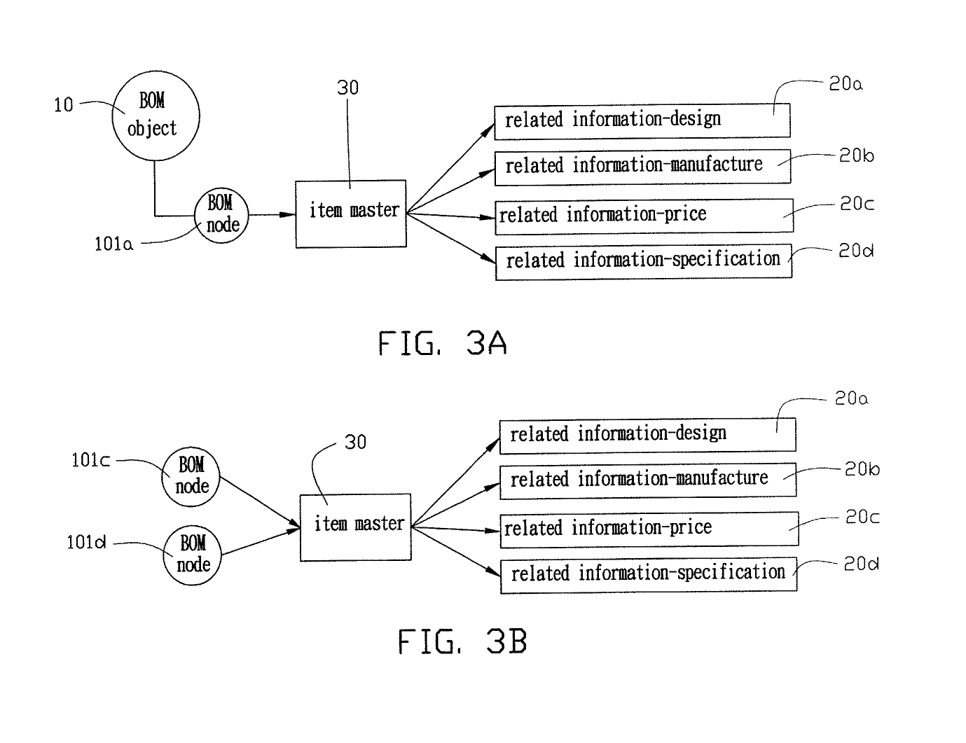

Exclusive links record the relation between the BOM node 101 and logically related information. The relation may be one to many, many to one, or many to many. For example, a product BOM node 101a may be linked to categories of information such as design (20a), manufacture (20b), price (20c), and specification (20d). If these categories of information are logically linked to the item master 30 of the BOM node 101a, an exclusive link relation of one to many is created (see FIG. 3A).

By contrast, a product BOM object 10 may be used in different projects. Such projects might include a product development project and a sales project. A BOM node 101c may be created for the development project, and a BOM node 101d may be created for the sales project. The created BOM nodes 101c and 101d are taken as different information objects. The BOM nodes 101c and 101d are still linked to the same item master 30 of the BOM object 10. The BOM nodes 101c and 101d are thus linked to the same corresponding DB objects 20 via the same item master 30. An exclusive link relation of many to many is created (see FIG. 3B).

In the information system, users preferably use a BOM object 10 to create, search, manage, or modify any information related to an information object. Each B OM object 10 has a graphical user interface and a hierarchical tree structure of BOM nodes 101 to allow users to perform such tasks.

The above description details the interrelationships between the BOM object 10, the BOM node 101, the DB object 20 and the item master 30, and their respective functions. All related information of a product is stored in corresponding DB objects 20. The actual structure of the product is represented by the tree structure of the BOM object 10. All components of the product are represented by a plurality of BOM nodes 101 which are exclusively linked to corresponding DB objects 20 via the item masters 30. When a user wants to add, modify or change a DB object 20, he must perform such action on the BOM node 101 or a BOM object 10 which corresponds to that DB object 20. Accordingly, the adding, modifying or changing of the DB object 20 can be directly seen in the user interface of the BOM node 101 or BOM object 10. An action or operation on a BOM node 101 is classified into three types: adding a new BOM node, using an old BOM node, and modifying a BOM node.

A user must perform any of the above-described operations according to a version management rule. The version management module 40 then automatically rebuilds or updates the item master 30 and the exclusive links of the item master 30. The version management module 40 thus manages all versions of each information object.

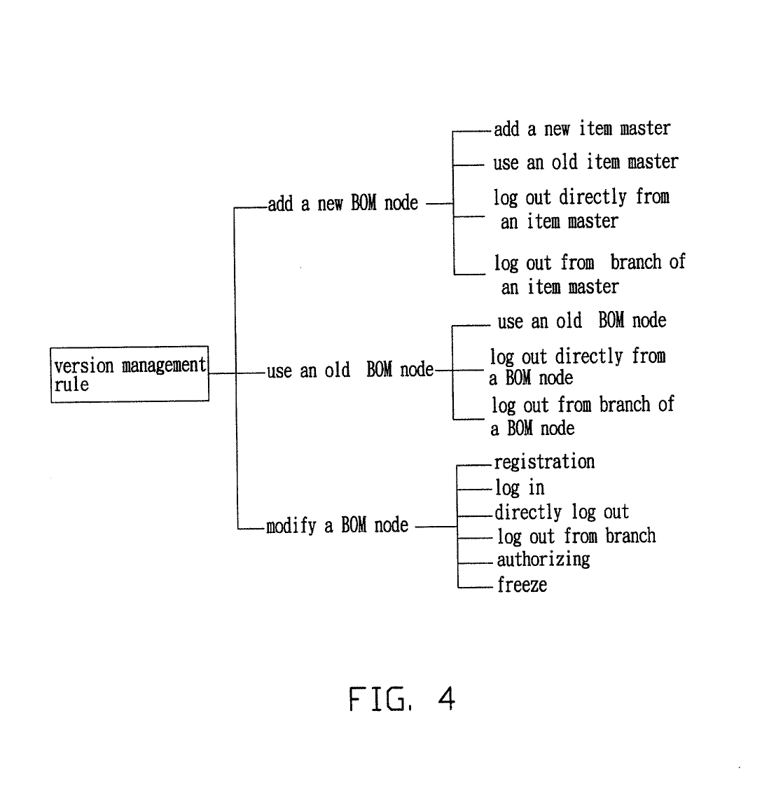

As shown in FIG. 4, the version management rule comprises:

1: A sub-rule of adding a new BOM node 101. This sub-rule applies only when a new BOM node is added. According to this sub-rule, when a new BOM node 101 is being added, the version management module 40 automatically performs one of the under-mentioned functions to add a new BOM node into the information system. The functions comprise: add an item master of a new product, use an old item master, log out the item master directly (hereinafter called “check out”), and log out the item master from branch (hereinafter called “branch out”).

2: A sub-rule of using an old BOM node 101. This sub-rule applies only when an old BOM node 101 which already exists in the information system is being used. According to this sub-rule, when a user continues to use an old BOM node 101, the version management module 40 automatically performs one of the under-mentioned functions to use the old BOM node 101 already existing in the information system. The functions comprise: use an old BOM node, log out BOM node directly, and log out BOM node from branch.

3: A sub-rule of modifying a BOM node. This sub-rule applies only when a user modifies a BOM node 101. That is, for example, when the user modifies the structure or specifications of a subassembly of a BOM object 10 According to this sub-rule, when a user modifies a BOM node 101 already existing in an information system, the version management module 40 automatically performs one of the under-mentioned functions to modify a BOM node 101. The functions comprise: “registration”, login, “check out”, “branch out”, authorization, and freeze.

Each of the above-mentioned sub-rule functions are now described in more detail:

1. Add a new BOM node: Adding a new BOM node which does not belong to the original information system.

2. Login: A newly-created information object is transferred by the user from a local personal computer (PC) to an information system. Once the transfer is completed, the user loses the right to modify the information object.

3. Logout: If the user at the local PC wants to modify the information transferred to the information system, he must ask the information system for permission of “logout”. After obtaining the permission, the user can modify the information and transfer the modified information to the information system by “login.”

There are two ways to log out from a BOM node 101: “check out” or “branch out.” In “check out”, when a user logs out from a particular BOM node 101, no other user is permitted to log out from the same BOM node 101. In “Branch out”, many users can log out from the same BOM node 101 simultaneously In this situation, each user must log out from the BOM node 101 by “branch out.” The modified data resulting from each “branch out” are independent from the modified data resulting from all other simultaneous “branch outs.” That is, the versions of the modified BOM objects resulting from “branch out” and login are distinguishable from each other. The item master 30 records the original version and all modified versions of each BOM object.

4. Registration and authorization: If a user needs to upload an information object to the information system through “login”, the user has to get “registration” permission from the information system. The information system automatically assigns a registration number to the information object after the “login” has been performed.

5. Freeze: An information object has been fixed in final form, so that no more modification is allowed. Therefore the version of the frozen information object is a final version.

6. Use an old BOM node: This usually refers to using a BOM node 101 or a BOM object 10 which already exists in the information system. When a new BOM object is added by the user.

If the user logs out from a BOM node 101, the modified BOM node is subsequently transferred to the information system by using “login”. A new version of the BOM node 101 is then created in the information system. At the same time, a new version of all DB objects 20 and of all item masters 30 that the new version of the BOM node exclusively links to is created, and the relation with the old version is recorded. However, all reference files are retained unaltered.

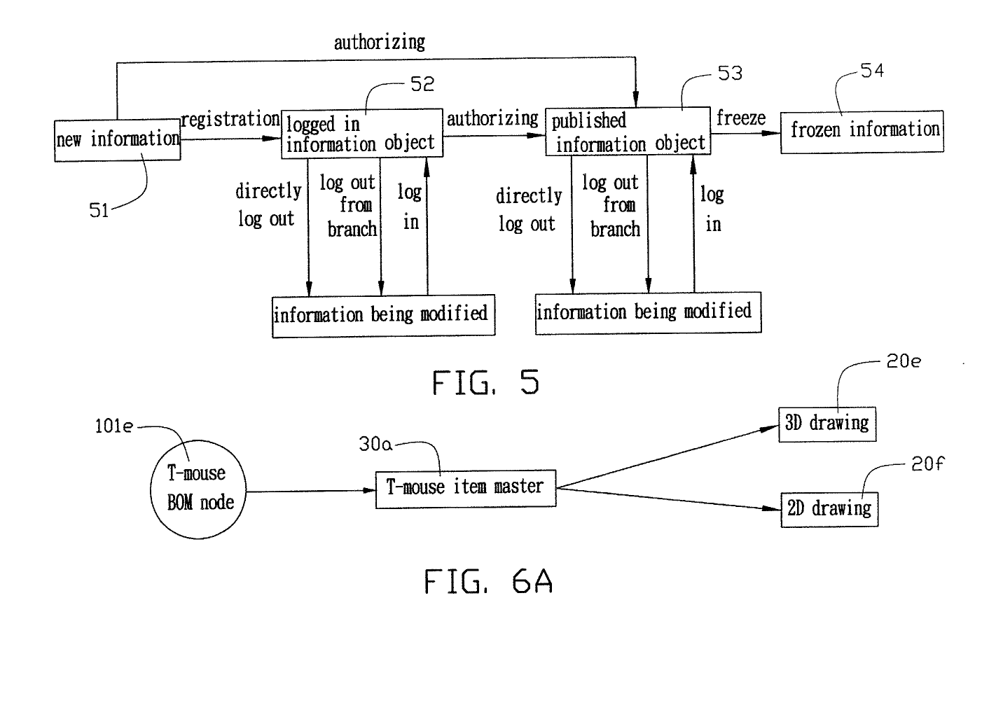

Referring to FIG. 5, the workflow of each information object in the whole information system is controlled by a version management module 40. The workflow is now described in detail:

At first, a user at a local PC creates a new record of information 51 which comprises a BOM object, several BOM nodes 101 and several related DB objects 20. The user then asks the information system for “registration”. At this time, the new record of information 51 has not been assigned with a registration number. According to the rule of adding a new BOM node, the version management module 40 adds a new item master exclusively linked to a BOM node 101 and DB objects 20 in the information system. This is done via the function of adding a new item master. After obtaining permission from the information system, the new record of information 51 is assigned with a registration number. At this time the process of “login” has been finished, and the new record of information 51 is validated as a logged in information object 52.

Managers read and check the logged in information object 52, and get “authorizing” permission from the information system. The information object 52 is thus validated as a published information object 53. The published information object 53 is a formal version, and is said to be “issued.” If the published information object 53 requires no further modification, it is validated as a frozen information object 54 by the function “freeze”. The frozen information object 54 is a final version, and modifying or changing it is forbidden.

If a user does not have “registration” permission from the information system, the user can modify the logged in information 51 by “check out” or “branch out.” The same principle to the published information 53, after passing the managers' checking, the users can still modify the formal version of published information objects 53 by using “check out” or “branch out”, then can use “login” to create another record of logined information.

In addition to the function items described above, the version management module 40 has the following functions:

1. Referring to a BOM node: A reference BOM node is defined as a BOM node in a newly created BOM object, whereby the BOM node continues using existing information in DB objects. Therefore, when a user selects the function item “referring to a BOM node”, the user has no right to modify the BOM node in this BOM object. The version management module 40 only links the BOM node information existing in the information system to the tree structure of the newly designed BOM object. The item master and DB objects linked to the reference BOM node are both in a state of formal version that is not allowed to be modified. Therefore, the user cannot modify the reference BOM node unless he applies for and obtains authority to modify from the information system.

2. Copying a BOM node: When a user copies a BOM node which already exists in the information system, the related item master and the exclusively linked DB objects related to the BOM node are also automatically copied. Logical links among the new copied item master, the new copied BOM node and the new copied DB objects are thus established. At this time, a logic link between the original reference file and the new BOM node is established. Therefore, by copying, a new duplicate framework comprising the new BOM node, new item master, and new DB objects in the information system is created. The new BOM node and the old BOM node are linked to the same original reference file. The only difference is in that the new item master does not have registration from the system. That is, the new item master does not have a registration number, and is in a state of “adding”.

3. Canceling a BOM node: There are two kinds of canceling actions for a BOM node. One is to delete a BOM node directly, and the other is to put a copied or logged out BOM node back into the information system. In the first canceling action, information of the BOM nodes is deleted from the information system. The item master and exclusive DB objects that the BOM node linked to would be retained unaltered. In the second canceling action, a copied or logged out BOM node is reverted to the state where the BOM node was not copied or logged out.

Before getting a registration number, the new added BOM node can be deleted directly. Once the new BOM node has a registration number, a user must use the function of “put back” to delete the node, the item master and the exclusively linked DB objects that were created in the process of getting the registration number. When a BOM node and its corresponding item master are in the state of “adding”, they are not yet authorized to be formal versions. They cannot be consulted, copied or logged out by a new created BOM object or BOM node in other plans in the information system. So, the function of “put back” a particular BOM node is limited to the item master related to the node and all exclusive files in the same plan. If the user deletes a DB object that is exclusively linked, the information system automatically checks if there are other BOM nodes either exclusively or referentially linked to the DB object. If the result of such check is positive, the system automatically preserves the DB object.

The effects of using the “delete” and “put back” functions on a reference link are similar. However, they differ regarding severing of the link between the node and the tree structure. The user cannot delete the reference node by using “delete” function, unless the user deletes the link as follows: As with deleting a formal version, in addition to getting authorization from the information system, the user must apply to the information system for modification. After the system grants authorization and modification, the user performs the “freeze” function on the reference BOM node. Since all the reference BOM nodes are formal versions, the “freeze” process is suitable for the reference BOM nodes.

4. Deleting a link: In many cases in practice, each BOM node is referentially linked. To delete the link means to remove the BOM node from the tree structure. However, the BOM node itself is reserved in the information system. The information of the BOM node can still be referred to in other plans. Therefore when using the “delete link” finction, a user can only modify the tree structure of the selected BOM node in the user's particular plan. If other plans use the old version of the deleted BOM node tree structure, the other plans will not be affected by the “delete link” operation. This is because the tree structures of the modified BOM object referred to in other plans must be normal versions. If the user wants to modify the tree structures of the BOM object, he must apply to the information system for permission to “modify application”. After such permission is granted, the user uses a “new issue” function to log out the old version, and creates a new version of the BOM object. Without special commands, this new version will not be linked to the tree structures of BOM objects that have used the tree structure of the old version of the BOM object. The user can find all tree structures uplinked to the BOM object by using a “viewing” function provided by a related database management system. After using the “modify application” function and getting permission from the information system, the user can uplink the related structure to the new BOM object. This renews all the links related to the new BOM object. Finally, the user can check and publish the whole BOM structure.

Four practical examples are now described to help explain the management system and method of the present invention.

### EXAMPLE 1

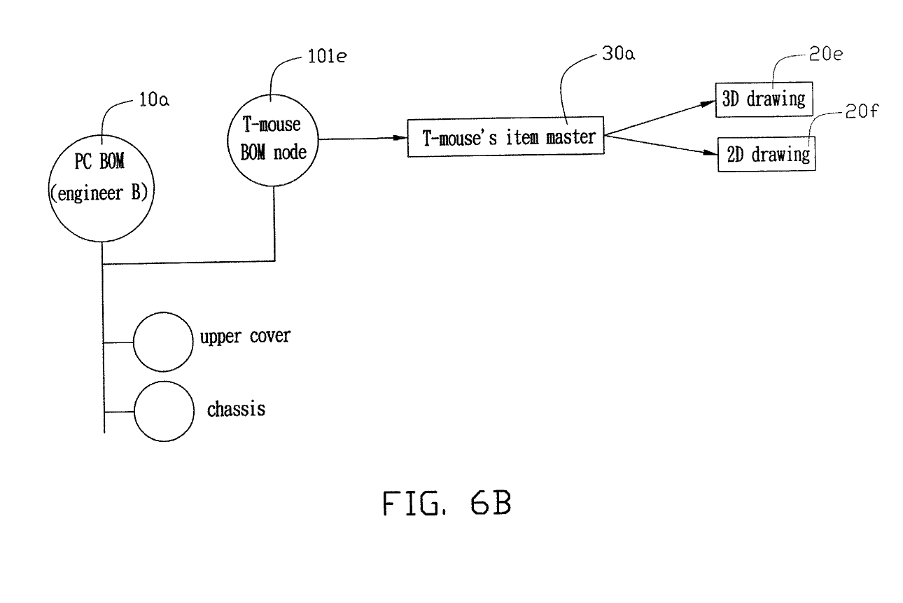

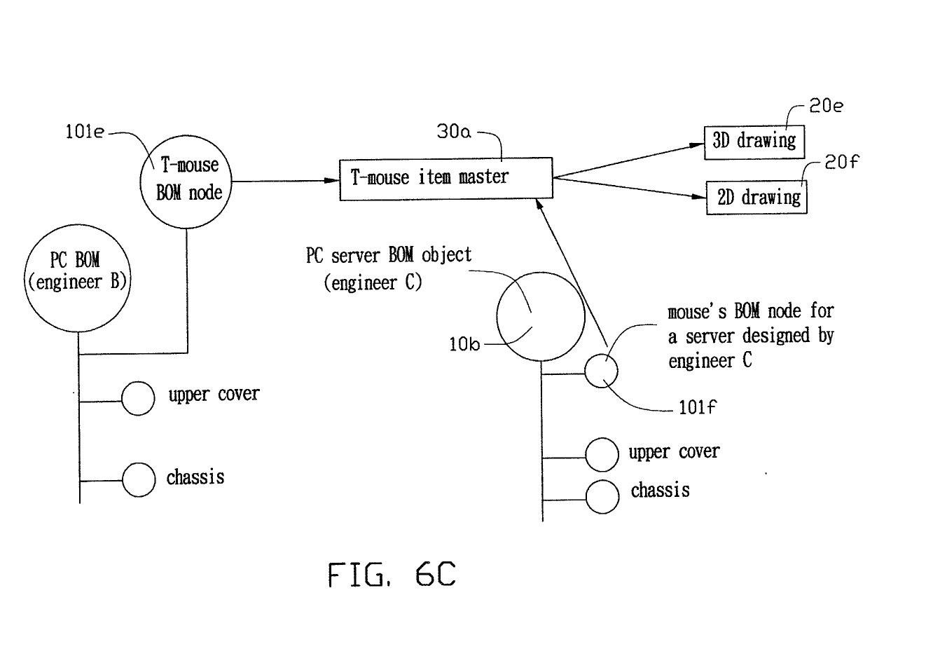

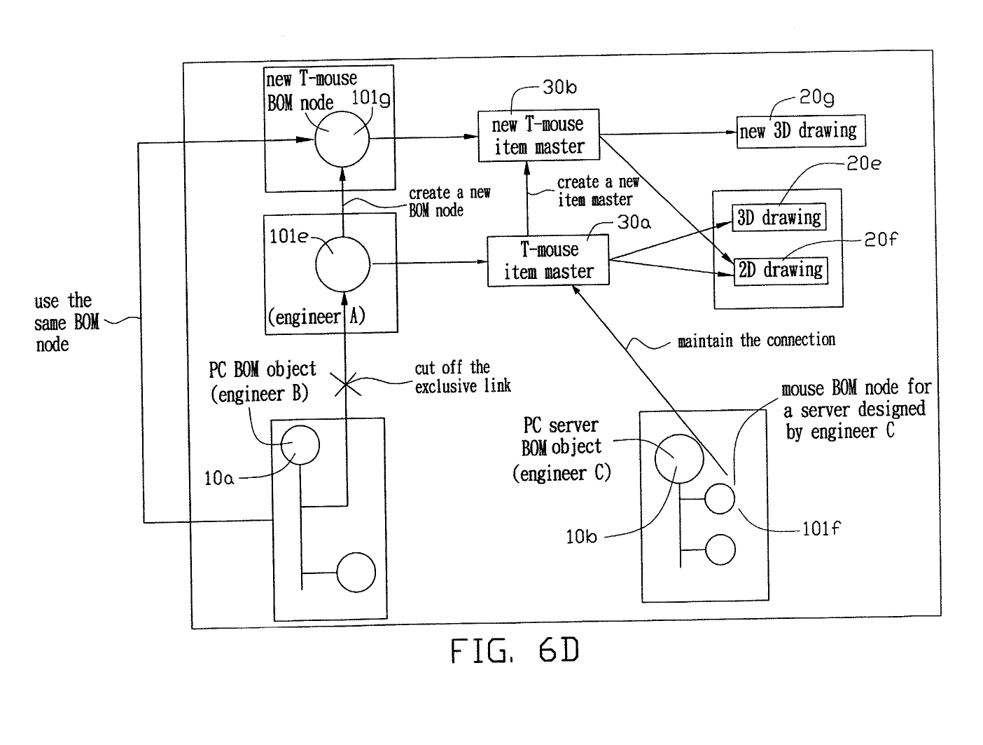

Referring to FIG. 6A, assume that on Oct. 1, 2000, a design engineer “A” created a new BOM node named “T-mouse BOM node 101e.” The engineer “A” also produced a new product item master named “T-mouse item master 30a” in the information system. The 3D drawing 20e and 2D drawings 20f relating to “T-mouse BOM node 101e” were exclusively linked to “T-mouse item master 30a.” Thus the information of the “T-mouse BOM node 101” was created.

### EXAMPLE 2

Referring to FIG. 6B, assume that on Oct. 10, 2000, as a design engineer “B” designed a PC. Engineer “B” wanted to use the latest version of the T-mouse with his designed PC, and have his designed PC incorporate updated versions of the T-mouse. Therefore, the engineer “B” made the “T-mouse BOM node 101” created by engineer “A” exclusively link to his newly-created “PC BOM” object 1Oa.

### EXAMPLE 3

Referring to FIG. 6C, assume that on Oct. 15, 2000, a design engineer “C” designed a PC server. Engineer “C” wanted to use a mouse with his newly-designed server. Engineer “C” searched many published product item masters 30 in the information system, and found the “T-mouse item master 30” created by engineer “A.” Engineer “C” felt that the T-mouse in “T-mouse item master 30” was suitable for his PC server. But engineer “C” did not want the latest updated design of the T-mouse to automatically replace the original design in his newly-designed PC server without him being shown the updated design in advance. So, engineer “C” created a new BOM node 101f, named it “mouse BOM node for a server designed by engineer C”, and exclusively linked it to “T-mouse item master 30a”. The “mouse BOM node for a server designed by engineer C” and the “T-mouse BOM node” created by engineer A were thus linked to the same “T-mouse item master 30a.” Nevertheless, the “mouse BOM node for a server designed by engineer C” and the “T-mouse BOM node” were otherwise independent BOM nodes. That is, each of these nodes could subsequently function within the information system as required by users and in accordance with the version management rule.

### EXAMPLE 4

Referring to FIG. 6D, assume that on Nov. 10, 2000, design engineer “A” redesigned the original T-mouse to create a new T-mouse. Engineer “A” had to ask the information system for permission to log out the previous “T-mouse's BOM node.” After getting authorization, engineer “A” logged out the “T-mouse item master” and all exclusively linked DB objects 20, and carried out the redesigning. After finishing the redesigning, engineer “A” logged in the new 3D drawing DB objects 20g, the “new T-mouse item master 30b” and a “new T-mouse's BOM node 101g” into the information system. At this time, the version management module 40 automatically cut off the exclusive link between the “PC BOM” object of engineer “B” and the original version of “T-mouse BOM node”, and created a new exclusive link between the “PC BOM” object and the “new T-mouse BOM node”. Thus engineer “B” automatically had the updated design of the T-mouse incorporated into his designed PC. The “new T-mouse item master” was automatically marked by the version management module 40 as being different from the original “T-mouse's item master.” Since the “mouse BOM node designed by engineer C” still exclusively linked to the original “T-mouse item master”, the PC server designed by engineer “C” still incorporated the original design of the T-mouse.

Normally, an enterprise has to design and prepare several versions of a single product to meet customers' various demands. By using the management system and method as disclosed in the present invention, users can conveniently manage and use a variety of versions of information objects relating to the product. In particular, after publishing of a formal version of the product, a project leader in charge of development of the product as well as design engineers can use “branch out” to modify the formal version of the created BOM object simultaneously. Such persons can simultaneously share all information created, as well as easily distinguish between different versions of the originally created BOM object without interfering with each other. This is accomplished by the version management rule of the present invention.

What is claimed is:

1. A management system for management of original and modified forms of electronic information, the system comprising:
a bill of material object having a tree structure and comprising a plurality of bill of material nodes for storing information about a product in a hierarchical structure;
a database object for storing information related to the bill of material nodes;
an item master which logically links to the bill of material node and the database object to establish an exclusive link between the bill of material node and the database object; and
a version management module for renewing the content of a corresponding item master of a bill of material node and a corresponding exclusive link when a user adds to, uses or modifies the bill of material node.

2. The management system of claim 1, wherein the bill of material nodes store information about structure of a product.

3. The management system of claim 1, wherein the bill of material nodes store information about a plan.

4. The management system of claim 1, wherein the bill of material nodes store information about structure of an organization.

5. The management system of claim 1, wherein the information stored in the database objects is stored in any one or more of the following forms: document, database, video, image, audio.

6. The management system of claim 1, wherein the item master records all original and modified information of its exclusively linked bill of material node.

7. A management method for management of original and modified forms of electronic information, the method comprising the steps of:
establishing a bill of material object, a database object, an item master and a version management module which together constitute an information system, wherein the bill of material object comprises a plurality of bill of material nodes; and
establishing a version management rule, the rule comprising:
a sub-rule of automatically adding a new bill of material node into the information system when the new bill of material node is created by a user;
a sub-rule of using an old bill of material node already existing in the information system as an element for a newly created bill of material node; and
a sub-rule of modifying a bill of material node by automatically adding a new bill of material node and a new item master which is exclusively linked to the newly added bill of material node, the newly added bill of material node being exclusively linked to related database objects through the newly added item master; and
facilitating the version management module executing corresponding sub-rules of the version management rule when adding a new bill of material node, using an old bill of material node or modifying a bill of material node.

8. The management method of claim 7, wherein the step of establishing a bill of material object comprises creating a tree structure comprising a plurality of bill of material nodes which are used to store information about a product in a hierarchical structure.

9. The management method of claim 7, wherein the database object comprises information related to the bill of material nodes.

10. The management method of claim 9, wherein the information related to the bill of material nodes has any one or more of the following forms: document, database, video, image, audio.

11. A method for sharing data information of similar or same material among different users, comprising:
providing specific information in a database device by a first user;
setting up a first bill of material node and an item master creating a relation between the specific information and the first bill of material node by said first user;
allowing a second user to approach said specific information; and
setting up second bill of material node referring to said item master to create another relation between said specific information and said second bill of material node by the second user, wherein to the same item master, said two bill of material nodes are independent from each other so that the second user can still approach the specific information via said second bill of material node under the same item master even if the first user cuts off the first bill of material node.
